(19) United States
(12) Patent Application Publication
(10) Pub. No.: US 2005/0144580 A1
(43) Pub. Date: Jun. 30, 2005

(54) Method and system for testing a logic design

(76) Inventors: Daniel A. Berkram, Fort Collins, CO (US); Daniel W. Krueger, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/732,394

(22) Filed: Dec. 10, 2003

(51) Int. Cl. G06F 9/45

(52) U.S. Cl. 716/6

(57) ABSTRACT

A method of testing a logic design in one disclosed embodiment includes identifying a plurality of clocked logic elements of a first logic design. The plurality of logic elements is subdivided into M individual groups of elements. A distinct pseudo-clock is assigned to each of the M groups such that each of the M groups of logic elements is associated with a distinct clock domain in a second logic design. A simulation is performed on the second logic design with the M pseudo-clocks.

### BACKGROUND

Integrated circuits are typically very complex and require numerous iterations of design and verification. Typically, a number of different levels of simulation are used to verify an integrated circuit. Examples of simulation levels ranging from the most abstract to the most detailed include: behavioral, functional, static timing analysis, gate-level, switch-level, and transistor or circuit-level simulation.

Although proper system operation may be verified at one simulation level, verification may fail at a more detailed simulation level as a result of accounting for more variables in the physical environment. Timing performance, for example, may be affected by a number of environmental influences that are typically ignored at higher levels of simulation. Verification of the timing performance is handled at lower levels of simulation that take such environmental influences into consideration.

Circuit-level simulation can be used to verify timing performance. As a practical matter, however, circuit-level simulation is unwieldy for a large number of transistors or elements due to the enormous computational complexity. Thus timing performance is typically verified by gate-level and switch-level simulation.

Gate-level simulation treats logic gates as black boxes modeled by a logic function with input variables defined by the input signals. Switch-level simulation adds another level of detail to the physical realization of the logic gates by modeling individual transistors of the logic gates as switches that are either on or off. Switch-level simulation provides verification that the physical implementation of a logic design obtains the same logical results anticipated by the gate-level simulation.

Some environmental influences may create timing anomalies that affect the time of received clock signals. Clock edges presented at slightly different times to distinct groups of clock dependent logic may result in an improper logical result. Even if accurate circuit models are used to account for various elements of delay associated with individual circuit elements, the delays are expected to be deterministic. Other sources of delay may be present in the system. Typical gate-level and switch-level simulators do not account for varying delays in a common clock signal that might be the result of physical phenomenon such as jitter.

Jitter can have deterministic as well as non-deterministic effects on a clock. Jitter can vary across the integrated circuit such that the change in the received clock is different at distinct physical locations. This variation in the clock can create race conditions resulting in unexpected logical behavior. Such race conditions are detrimental to the planned operation of the integrated circuit. Analysis of a complex integrated circuit design without regard to jitter effects may result in a false verification of the logic design.

### SUMMARY

In view of limitations of known systems and methods, various methods and apparatus for testing a logic design are described. One method includes identifying a plurality of clocked logic elements of a first logic design. The plurality of logic elements is subdivided into M individual groups of elements. A distinct pseudo-clock is assigned to each of the M groups such that each of the M groups of logic elements is associated with a distinct clock domain in a second logic design. The second logic design is simulated using the M pseudo-clocks.

### BRIEF DESCRIPTION OF THE DRAWINGS

FIG. 1 illustrates various levels of abstraction for modeling an integrated circuit.

FIG. 2 illustrates the effect of jitter on a clock signal.

FIG. 3 illustrates a logic design including a plurality of logic elements sharing a common clock.

FIG. 4 illustrates a logic design having a plurality of independent clocks.

FIG. 5 illustrates a plurality of clock signals to be applied in various combinations to edge-triggered flip-flop circuitry.

FIG. 6 illustrates the effects of clocking the flip-flop circuitry with clocks exhibiting various timing anomalies including jitter.

FIG. 7 illustrates one embodiment of a method of testing a logic design.

FIG. 8 illustrates one embodiment of a method of testing a logic design.

FIG. 9 illustrates conversion of a first logic design having a single clock domain to a second logic design having a plurality of clock domains.

FIG. 10 illustrates clock edge alignment variations for simulating jitter on a clock shared by a plurality of logic elements.

FIG. 11 illustrates one embodiment of a method for testing a logic design comprising a plurality of clock domains.

FIG. 12 illustrates generation of a plurality of pseudo-clocks.

FIG. 13 illustrates one embodiment of a computer architecture for performing a switch-level simulation of a netlist.

FIG. 14 illustrates one embodiment of a method for simulating jitter using randomized test vectors.

### DETAILED DESCRIPTION

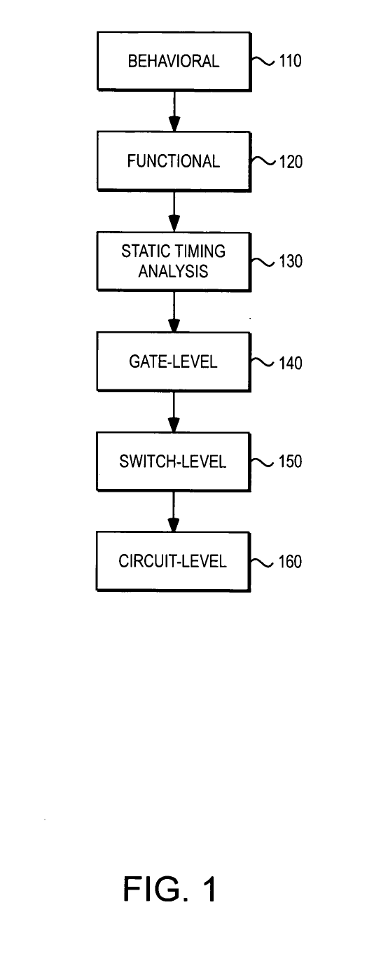

Integrated circuits are typically very complex and require numerous iterations of design and verification of the design at different levels of abstraction. FIG. 1 illustrates simulation levels ranging from the most abstract (behavioral 110) to the more detailed (circuit-level 160).

The availability of different levels of abstraction inherently implies that the varying simulation levels analyze the logic design at different levels of detail. The greater the amount of detail, the greater the computational resources and time that are required to simulate the logic design. Choice of the level of simulation is dependent upon the stage of integrated circuit design.

Although proper system operation may be verified at one simulation level, verification may fail at a more detailed simulation level due to the accounting for contribution of more variables in the physical environment. Capacitive loading, for example, would be ignored in a behavioral 110 or functional 120 simulation.

A behavioral or functional simulation may be verified as logically or mathematically correct. When the behavior or function is physically realized using transistors and gates, however, timing and time delays must be accounted for. Timing performance is affected by a number of environmental influences. Verification of the timing performance is handled at lower levels of simulation.

Static timing analysis 130 identifies critical paths associated with the longest time delay in a logic design. Static timing does not analyze whether the results obtained in response to particular input values are correct.

Circuit-level 160 simulation may be used to verify timing performance. Circuit level simulation models include the non-linear behavior of individual transistors that the logic gates are built from. As a practical matter, circuit-level simulation is unwieldy for a large number of transistors or elements due to the enormous computational complexity. Timing performance is typically verified by gate-level and switch-level simulation.

Gate-level 140 simulation treats logic gates as black boxes modeled by a logic function with input variables defined by the input signals. Although some aspects of a physical implementation (e.g., deterministic delay) may be incorporated into a gate-level simulation, the attributes of physical devices used to implement the gate logic are largely ignored.

Switch-level 150 simulation is the first simulation level that considers physical devices used to implement a logic design. Switch-level simulation models individual transistors as switches that are either on or off rather than non-linear active elements. Switch-level simulation uses a simplified model of circuit elements for computational efficiency.

Even if gate-level and switch-level simulation can be based on element models having a delay component, such models are based on the presumption that delays are deterministic. Such models do not account for variations in a common clock signal that is otherwise expected only to experience predictable delay. In reality, however, phenomena such as jitter can inconsistently modify a clock along the clock signal path so clock edge transitions received by different circuit elements can lead or lag the intended clock edge transition of the common clock for any given clock cycle. The modification can also change unpredictably across clock cycles. Jitter in the clock signal is the deviation from the ideal or intended timing of the event (e.g., location of edge transitions). Jitter is composed of both deterministic and non-deterministic (i.e., random) content.

Deterministic jitter is bound in amplitude and has a traceable cause. Classes of deterministic jitter include duty cycle distortion, data dependent, sinusoidal, and uncorrelated bounded. Clock signals are susceptible to duty cycle distortion and periodic jitter. Deterministic jitter is typically caused by cross talk, simultaneously switched inputs/outputs (resulting in current/voltage spikes and changes in detection thresholds), electromagnetic interference, or recurring signal patterns.

Non-deterministic jitter is stochastic in nature. This random jitter is unbounded. Sources of random jitter include material imperfections, thermal vibration of semiconductor crystal structures, radiation, and other sources. Generally, the term “jitter” refers collectively to both deterministic and non-deterministic jitter.

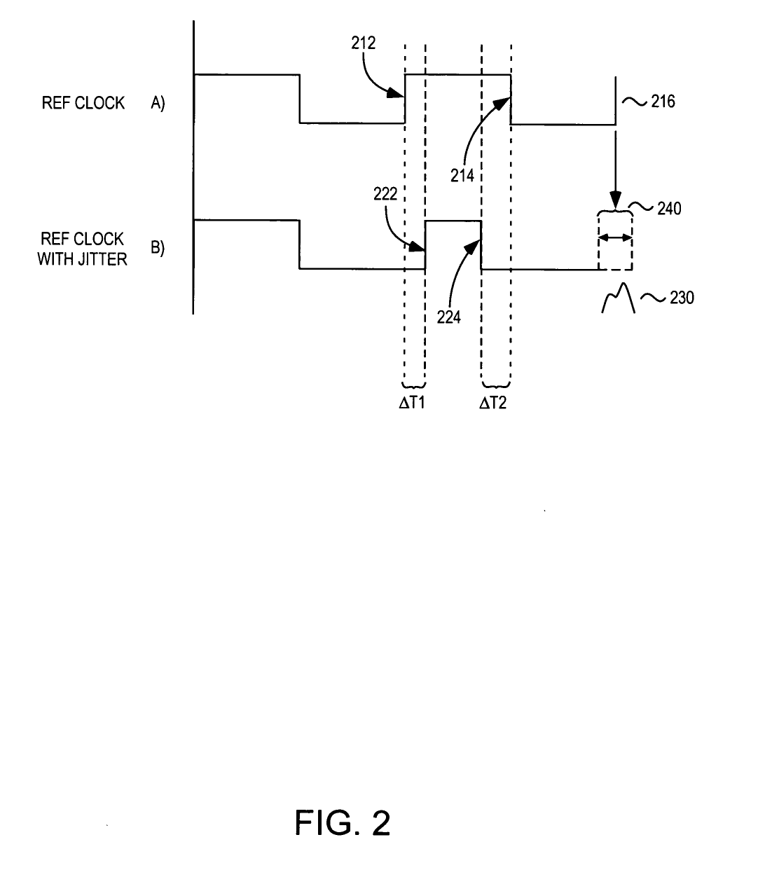

FIG. 2 illustrates a reference or master clock (waveform A) and one embodiment of the master clock with jitter (waveform B). One result of jitter is the displacement of the clock edge transitions from their ideal locations. Thus jitter can cause clock edges to lead or lag their ideal locations for any given transition such that the jittered clock edge leads the ideal location on one transition and lags the ideal location on another transition.

For example, jittered clock edge 222 lags reference clock edge 212 by a displacement ΔT1. Jittered clock edge 224 leads reference clock edge 214 by a displacement ΔT2. Generally, for a given clock edge location 216, the jittered clock edge will occur in a region 240 near the corresponding reference clock edge location. For any given clock cycle, the jittered clock edge location bears a statistical relationship to the ideal location (i.e., the corresponding reference clock edge transition) as indicated by probability distribution function 230.

A skewed clock generally refers to a clock having a fixed clock edge displacement (e.g., leading or all lagging by the same displacement every cycle) from a corresponding edge of the reference clock such that the skewed clock is a time-shifted version of the reference clock. The skewed clock duty cycle is the same as that of the reference clock. Unlike a skewed clock, the edge displacement of a jittered clock is not constant and can vary every cycle of the clock effectively varying the duty cycle of the clock.

When jitter causes a clock edge to shift substantially relative to logic gate hold or setup times, the result may be a logical anomaly. Frequently, the output of combinatorial logic or sequential logic may be logically incorrect immediately after a change in input signals or clock transition. After a determinate settling period, however, the circuitry has had an opportunity to settle and the correct output values are generated. Jitter can cause the circuitry to generate the incorrect result. Even worse, the jitter may cause the circuitry to generate the incorrect result in an inconsistent manner.

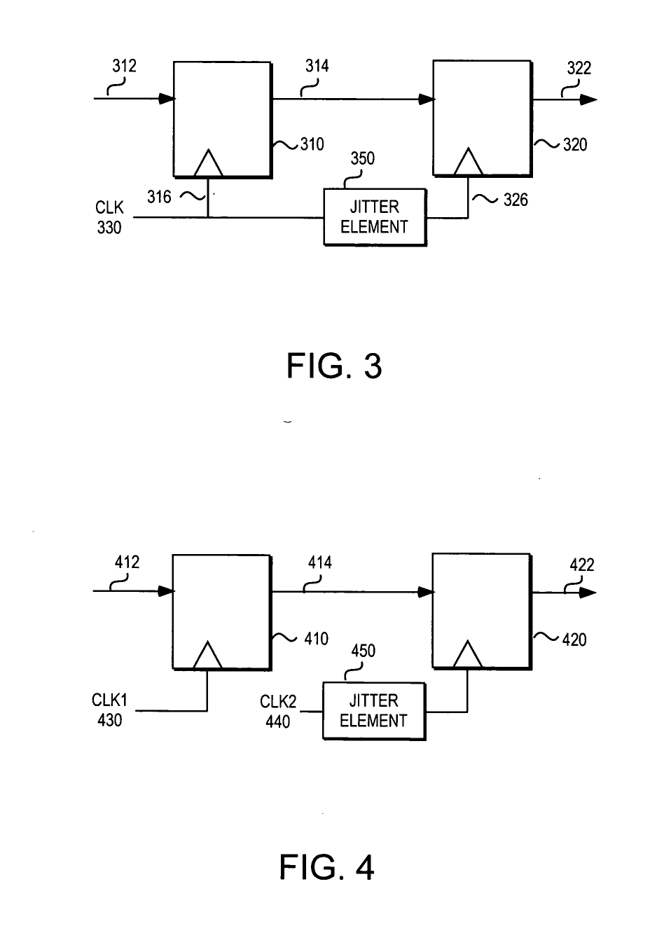

FIG. 3 illustrates edge-triggered flip-flop circuitry with a jitter element. From a design standpoint, flip-flops 310 and 320 are supposed to share a common clock signal 330. The input 312 of flip-flop 310 is latched as output 314 in response to a clock signal transition at clock input 316. The output 314 of flip-flop 310 is provided as the data input to serially coupled flip-flop 320. The output of flip-flop 310 is captured by flip-flop 320 and provided as output 322 in response to a subsequent clock signal transition at clock input 326.

Jitter element 350 represents a source of jitter that causes the clock at clock input 326 to be different from the clock at clock input 316. Although the logic may operate properly if the same jitter is present in both clock input 316 and clock input 326, the “differential” jitter between one clock input and another may cause a logic anomaly. Jitter can cause the clock transition presented to logic element 320 to be displaced from the clock transition presented to logic element 310.

Flip-flop 320 should effectively provide a one cycle delay in response to output 314. If the displacement is substantial, flip-flop 320 could capture or otherwise respond to the output 314 associated with the wrong clock cycle. A simulation that does not account for this possibility may provide false verification of the logic design.

Jitter element 350 may correspond to a logic element (e.g., gate) of the logic design. Jitter element 350, however, is illustrated for the purposes of showing a variation in the clock signals 316, 326 due to jitter. The jitter may in fact be the result of crosstalk due to physical layout, radiation, or some other phenomenon. Thus jitter element 350 need not be attributed to a specific component of the logic design.

Jitter can also cause a problem when there are groups of logic elements that do not share a common clock. Even if the groups use distinct clocks by design, the various clocks may be expected to transition in a close relationship with each other. Clocks of different frequencies, for example, may be expected to be edge aligned. This frequently occurs in communication system interfaces (modems, synchronizers) when transitioning from one communication protocol to another (e.g., framing). This may also occur when one clock is derived from the other clock, or when both clocks are derived from yet another clock for example, by a divide-by-n counter or other gate circuitry.

FIG. 4 illustrates logic elements 410 and 420 that are clocked by distinct clocks 430, 440. A value 412 latched by element 410 will be provided to the input 414 of element 420 for a window of time. If the edge of the clock presented to element 420 occurs during that window, then element 420 will effectively capture the value presented to its input. If the edge of the clock signal occurs outside of this window, however, element 420 will likely latch and output 422 the wrong value.

Jitter element 450 is provided to illustrate that the received clock signals 416, 426 may not be edge-aligned due to jitter. Even though the clocks may have different frequencies, the clock edges are expected to be aligned whenever conditions are appropriate for both CLK1 430 and CLK2 440 to transition. Jitter element 450, however, can contribute sufficient distortion such that the received signals 416, 426 are not aligned. This may result in a logic anomaly.

As with FIG. 3, jitter element 450 is provided to illustrate that a source of jitter may cause the clock edges to be mis-aligned. The jitter does not have to be attributed to any specific component of the logic design.

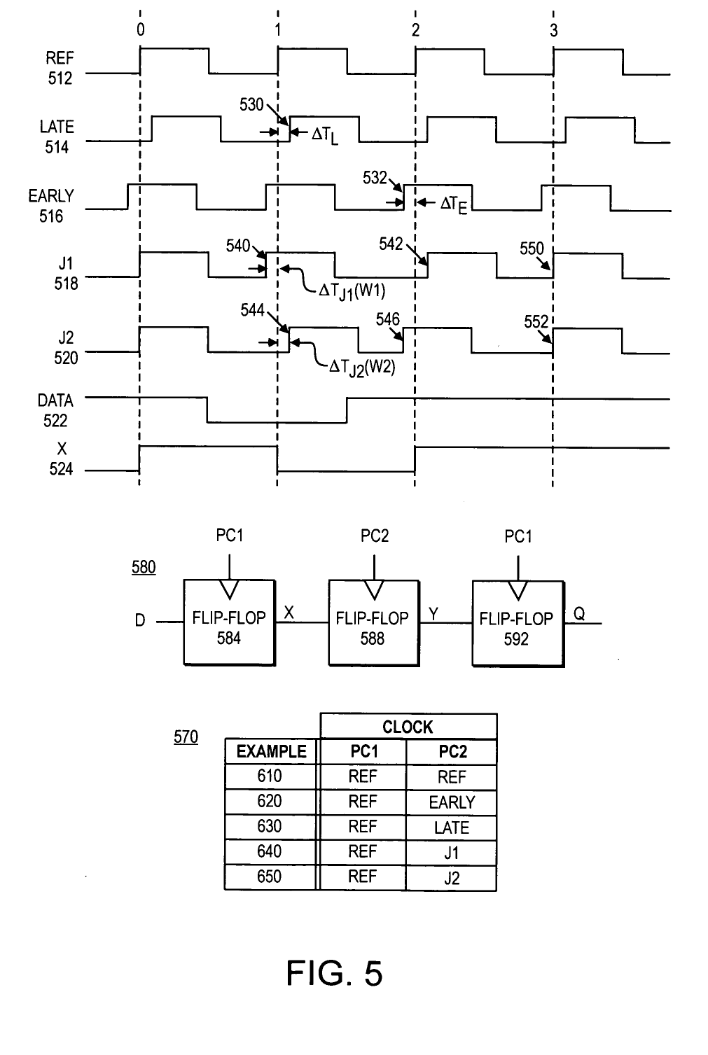

FIG. 5 illustrates a number of clock waveforms 514-520 having edge misalignment with respect to at least one corresponding edge of reference clock 512. Late clock 514 is delayed by a pre-determined amount ΔT_{L} from the reference clock 512. Early clock 516 precedes the reference clock 512 by a pre-determined amount ΔT_{E}. Jitter clock J1 518 illustrates one embodiment of a clock affected by jitter. Jitter clock J2 520 illustrates another embodiment of a clock affected by jitter.

ΔT_{L} represents the displacement of a selected edge 530 of the late clock 514 from the corresponding edge 1 of the reference clock 512. ΔT_{E} represents the displacement of a selected edge 532 of early clock 516 from the corresponding edge 1 of the reference clock 512. ΔT_{L} and ΔT_{E} are constant between clock cycles such that the same displacement occurs every clock cycle. Moreover, the leading and trailing clock edges are displaced by the same amount in each case. The duty cycle of each of the late and early clocks is constant and identical to that of the reference clock. The early and late clock waveforms thus represent skewed versions of the reference clock 512.

ΔT_{J1}(W1) is the displacement of a selected edge 540 of jitter clock J1 from the corresponding edge 1 of reference clock 512. ΔT_{J2}(W2) is the displacement of a selected edge 542 of jitter clock J2 from the corresponding edge 1 of reference clock 512. W1 and W2 represent random variables. Thus the value of ΔT_{J1}(W1) for one edge 540 may be different from the value of ΔT_{J1}(W1) at another edge 542 or 550. Similarly the value of ΔT_{J2}(W2) at one edge 544 may be different from the value of ΔT_{J2}(W2) at another edge 546 or 552. Unlike the skewed clock signals 514 and 516 characterized by a cycle invariant displacement, the edge displacement of the jittered clocks can vary from clock cycle to clock cycle.

Flip-flop circuitry 580 is designed to capture a data signal, D, in response to a reference clock edge transition. If all three flip-flops 584, 588, 592 share a common clock, then the serial coupling of the flip-flops should result in Q(t_{ref}+2)=Y(t_{ref}+1)=X(t_{ref}) such that Q is the same as X delayed by two reference clock edge transitions.

In the presence of jitter or other timing anomalies that modify the reference clock received by each flip-flop, the flip-flops might not behave as expected. In order to enable simulation of the behavior of the circuitry in the presence of such anomalies, the flip-flop circuits 584, 588, 592 do not share a common clock signal.

A plurality of pseudo-clocks is introduced to permit modeling variations in the clock received by the flip-flops. In particular, flip-flop 588 is provided with a different pseudo-clock (PC2) than the pseudo-clock (PC1) of flip-flops 584 and 592. This permits testing clock edge displacements that may vary across cycles.

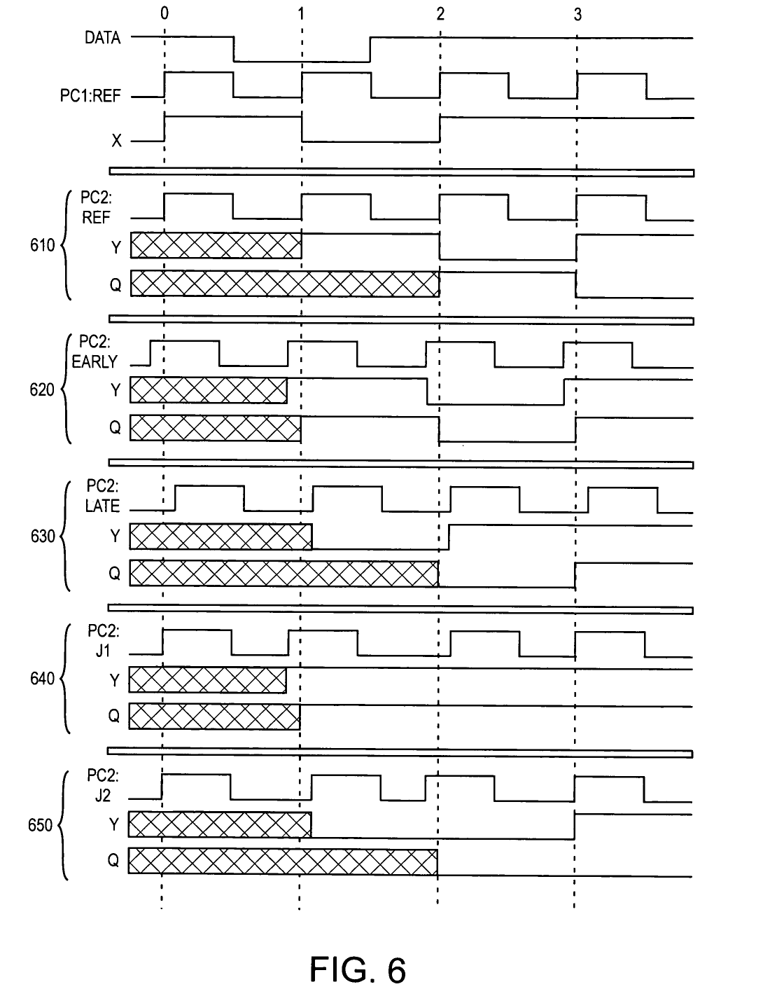

Table 570 identifies a number of examples and the combination of clock waveforms from the set of waveforms 512-520 used for PC1 and PC2 in each example. Thus Example 640 sets PC1=REF 512 and PC2=J1 518. These examples are detailed in FIG. 6 with the designated waveforms and the resulting Y and Q outputs.

Given that the clock input of the first flip-flop 584 is PC1 and PC1=REF 512 for every example, the output X of flip-flop 584 is the same for each example. Therefore waveform X 524 is illustrated once in FIGS. 5 and 6 rather than being repeated for each example of FIG. 6.

FIG. 6 illustrates the varying results of applying the reference clock (REF), late clock (LATE), or jittered clocks J1 or J2 to the clock input of flip-flop 588 while applying the reference clock to the clock inputs of flip-flops 584 and 592. The data (D), reference clock (REF), and output (X) of the first flip-flop are illustrated for comparison. The resulting Y and Q are illustrated for each example.

Referring to FIGS. 5-6, Example 610 illustrates the result for Y and Q given D 522 when PC1, PC2=REF 512. Example 620, illustrates Y and Q when PC2=EARLY. Example 630, illustrates Y and Q when PC2=LATE. Example 640 illustrates Y and Q when PC2=J1. Example 650 illustrates Y and Q when PC2=J2.

Output Q at time t_{ref}+2 should match output X (i.e., the same as D) at time t_{ref}. Comparing examples 610-650, only example 650 matches the expected result. (i.e., Q₆₅₀(3)=Q₆₁₀(3)=X(1); Q₆₄₀(3), Q₆₃₀(3) Q₆₂₀(3)≠X(1)). Note that the intermediate results of Examples 610 and 650 do not necessarily match even though the result at t_{ref}=3 is correct (e.g., Q₆₅₀(2)≠Q₆₁₀(2), but Q₆₅₀(3)=Q₆₁₀(3)). Given the random nature of jitter as opposed to skew, verification must test different combinations of leading and lagging edges for a given clock across cycles to ensure that the flip-flop circuit will function properly for a given D in the presence of some jitter.

Referring to the examples of FIGS. 3 and 4, the circuit operation should be simulated under each of the possible clock edge relationships for every cycle of the reference clock: i.e., that a selected edge of received clock signal 316, 416: 1) leads, 2) is aligned with, and 3) lags the received clock signal 326, 426. The choice of displacement may vary from clock edge to clock edge in order to accurately model jitter instead of merely clock skew. Simulation, however, does not permit the reference clock to have different values at the same point in time. Thus pseudo-clocks are introduced to enable simulation of jitter and other timing anomalies.

In order to enable modeling the effects of jitter, logic elements sharing a common clock signal are divided into a plurality of logic element groups. The common clock is replaced with a pseudo-clock for each group. After this conversion, simulation may be performed with test vectors that define the selected clock edges of pseudo-clocks at varying relative displacements (i.e., leading, aligned, or lagging) from cycle to cycle in order to determine sensitivity to jitter. For logic designs that already have distinct clocks that are expected to be edge-aligned when more than one clock transitions, the same simulation technique can be applied.

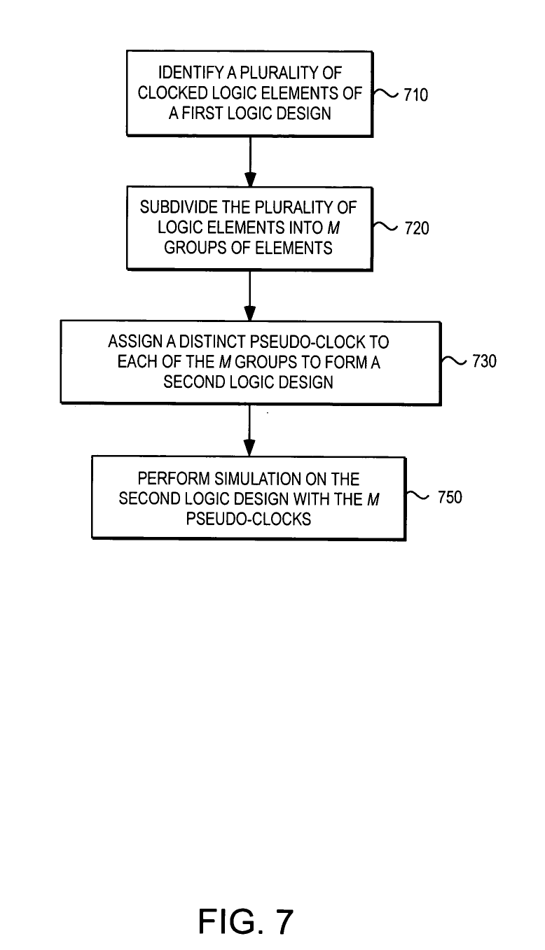

FIG. 7 illustrates one embodiment of a method of testing a logic design. A first logic design having a plurality of clocked logic elements is identified in step 710. The plurality of logic elements is subdivided into M groups of logic elements in step 720. (M is an integer greater than 1). Each of the M groups is assigned a distinct pseudo-clock to form a second logic design in step 730. This second logic design ensures that the clocking of each group can occur distinctly from the clocking of any other group even if the groups shared one or more common clocks in the first logic design. Simulation can be performed in step 750. In one embodiment, either a switch-level or a gate-level simulation is performed in step 750.

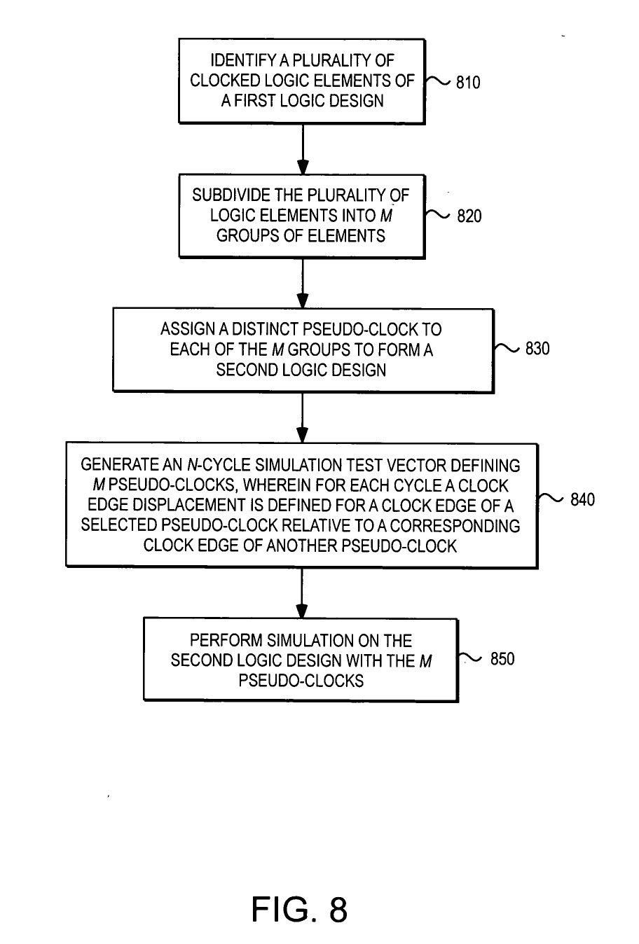

FIG. 8 illustrates one embodiment of a method of testing a logic design including generation of a simulation test vector. A first logic design having a plurality of clocked logic elements is identified in step 810. The plurality of logic elements is subdivided into M groups of logic elements in step 820. (M is an integer greater than 1). Each of the M groups is assigned a distinct pseudo-clock to form a second logic design in step 830. This second logic design ensures that the clocking of each group can occur distinctly from the clocking of any other group even if the groups shared one or more common clocks in the first logic design.

Although the clock edges for any two pseudo-clocks should be aligned to reflect the first logic design, jitter may cause the clock edge received by one group to lead or lag another clock edge of another group for a selected cycle of the same clock. This can be simulated by varying the displacement relationship between clock edges of the pseudo-clocks from cycle to cycle. In general, there are three possibilities for each cycle of any two pseudo-clocks. In particular, a selected clock edge of one pseudo-clock may lead, lag, or be aligned with the corresponding edge of another pseudo-clock for any selected cycle.

Thus in step 840, an N-cycle simulation test vector defines M pseudo-clock waveforms, wherein for each cycle a clock edge displacement is defined for a clock edge of a selected pseudo-clock relative to a corresponding clock edge of another pseudo-clock. The clock edge displacement may be leading, aligned, or lagging.

The relative displacement of the pseudo-clocks need not be constant from cycle to cycle. Thus a given test vector may incorporate aligned, leading, or lagging edges for a given clock cycle and a different alignment for a another clock cycle such that the relative displacement is not constant from clock cycle to clock cycle in order to test jitter.

In one embodiment, the displacement between the selected pseudo-clock and at least one other pseudo-clock varies across the N cycles such that there are at least two distinct displacements from the set of leading, lagging, or aligned. In an alternative embodiment, the relative displacement (i.e., leading, lagging, or aligned) is selected to be cycle independent in order to model skew. Once the simulation test vectors are generated, simulation can be performed in step 850. In one embodiment, either a switch-level or a gate-level simulation is performed in step 850.

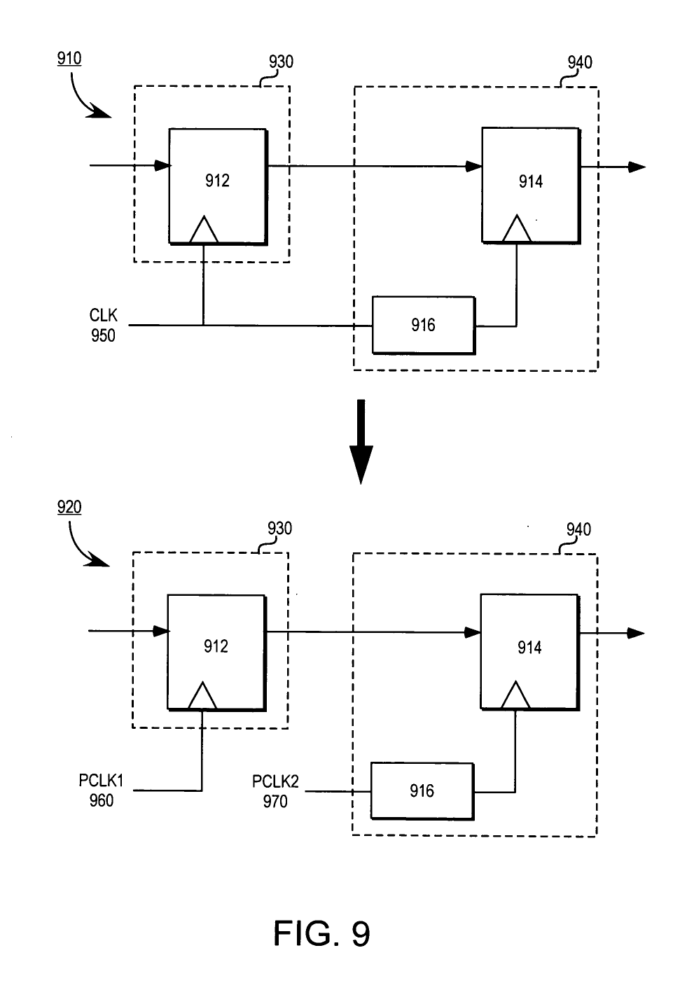

FIG. 9 illustrates subdivision of a first logic design 910 comprising a plurality of clocked logic components 912-916 sharing a common clock signal 950 into M distinct groups 930, 940. In the illustrated embodiment, the first logic design 910 is converted to a second logic design by replacing clock 950 input to each group with a pseudo-clock distinct from the pseudo-clock of any other group. Thus clock 950 is replaced with pseudo-clock 960 (PCLK1) for group 930 and pseudo-clock 970 (PCLK2) for group 940 such that each group has a clock that may transition independently of the clock associated with any other group for purposes of simulation.

Once each group has been assigned a pseudo-clock, the relative edge displacement of pseudo-clock edge transitions may be appropriately selected to verify proper circuit operation even in the presence of certain timing anomalies. In particular, for any given cycle a clock edge of a selected pseudo-clock may lead, lag, or be aligned with a corresponding edge of another pseudo-clock that is associated with another group.

For a single clock cycle any displacement might be referred to as skew, however, the “skew” may be varied from clock cycle to clock cycle to simulate jitter rather than a cycle independent skew. Thus the choice of displacement (i.e., aligned, leading, or lagging) may vary from clock cycle to clock cycle to model jitter rather than merely clock skew.

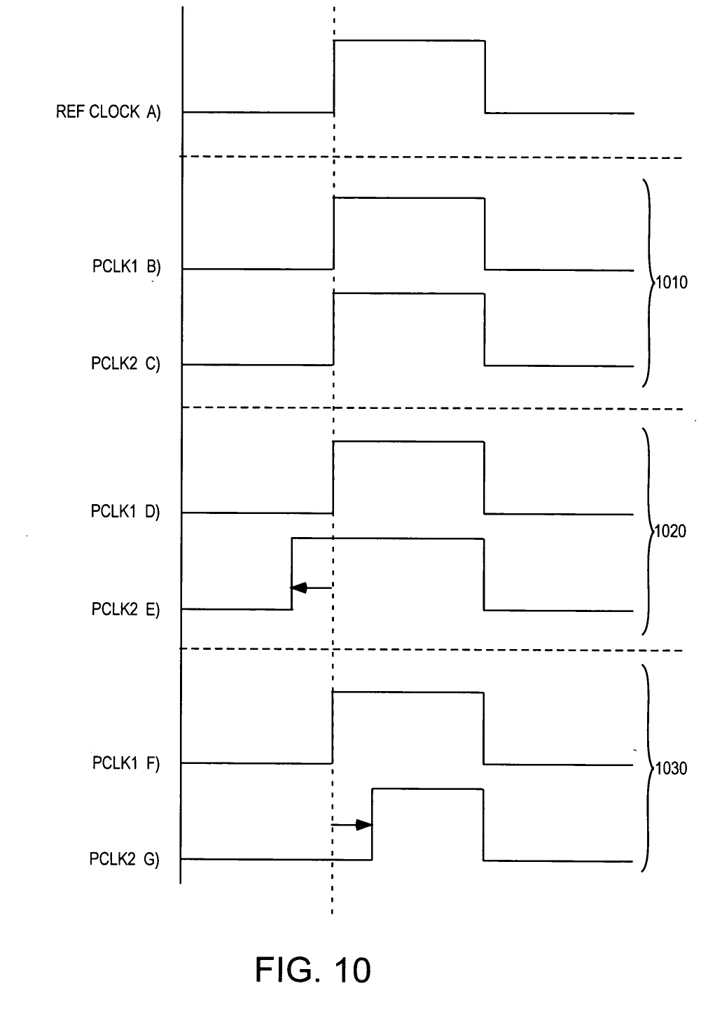

FIG. 10 illustrates the number of waveforms generated for M=2. Waveform a) represents the original or reference clock. When M=2 there are two pseudo-clock signals. In one embodiment, simulation tests combinations of relative edge leading, aligned, and lagging for each clock cycle. Simulation test vector 1010 represents pseudo-clock signals (PCLK1 and PCLK2) where the selected edge of PCLK2 is aligned with the corresponding edge of PCLK1. Simulation test vector 1020 represents pseudo-clock signals where the selected edge of PCLK2 leads the corresponding edge of PCLK1. Simulation test vector 1030 represents pseudo-clock signals where the selected edge of PCLK2 lags the corresponding edge of PCLK1.

Although each test vector illustrates a specific alignment option for a selected edge, subsequent cycles of any test vector may have different alignments than that of the selected edge to accurately model jitter rather than merely skew of the clock signal. Thus, for example, although the selected edge of PCLK2 leads the corresponding edge of PCLK1 in test vector 1020, a subsequent clock edge of PCLK2 might lag or alternatively be aligned with the corresponding edge of PCLK1. Varying the edge displacement in subsequent cycles permits modeling of jitter as contrasted with cycle independent skew.

A specific displacement relationship may be defined for each pseudo-clock relative to each other pseudo-clock. Alternatively, the displacement relationship may define the displacement of one pseudo-clock to the remaining pseudo-clocks.

In the event the original logic design already comprises a plurality of clock domains, further subdivision of the original logic design to produce more clock domains may not be required. Referring to FIG. 4, the original logic design may already have logic elements conveniently grouped into distinct clock domains that may be independently clocked during simulation.

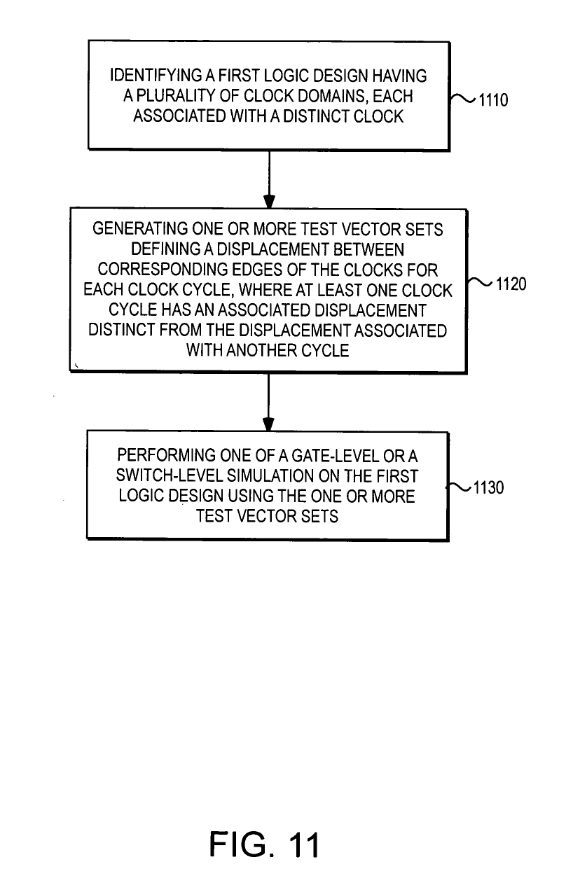

FIG. 11 illustrates one embodiment of a method of testing a logic design when further subdivision to create additional clock domains for simulation is not required. In the event any of the original clocks is dependent on another clock, the original clocks may be replaced by pseudo-clocks to ensure the ability to independently clock the distinct groups of logic elements during simulation.

In step 1110 a first logic design having a plurality of clock domains is identified. Each clock domain is associated with a distinct clock. In step 1120, one or more test vector sets defining a displacement between corresponding edges for the clocks for each clock cycle is generated. There is at least one clock cycle having an associated displacement distinct from the displacement associated with another clock cycle. One of a gate-level and a switch-level simulation is performed on the first logic design using the one or more test vector sets in step 1130.

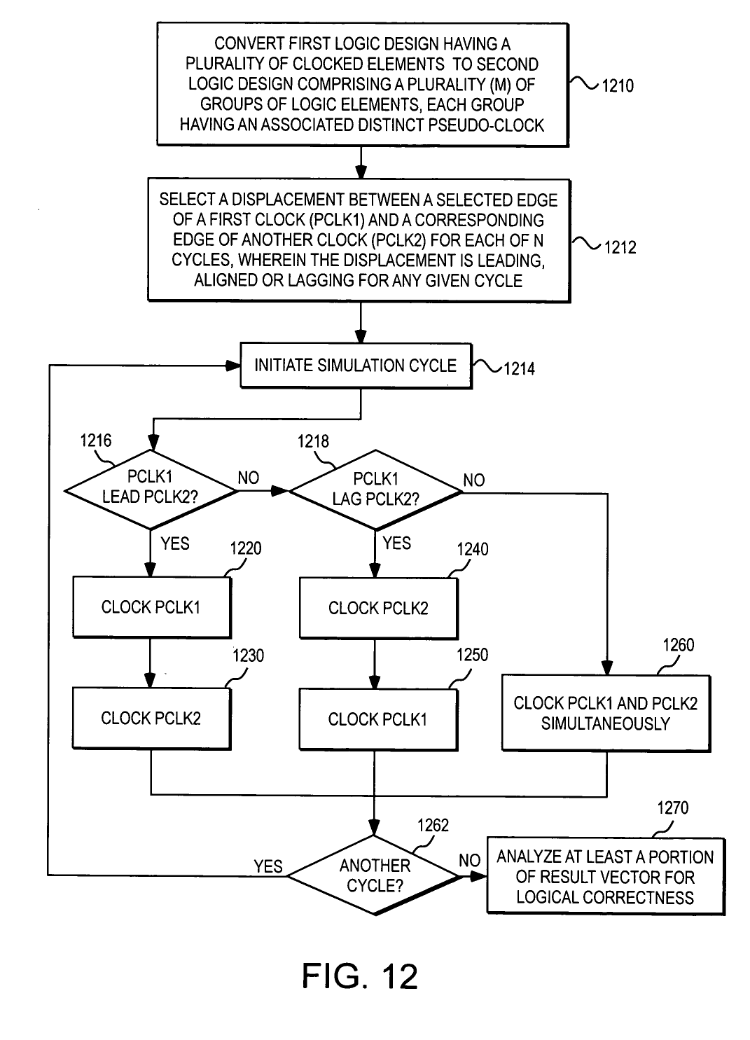

FIG. 12 illustrates one embodiment of a method of realizing various test vectors in a switch-level simulation environment. In step 1210, a first logic design having a plurality of clocked logic elements is converted to a second logic design having M groups of clocked logic elements, each group with a distinct pseudo-clock.

Although in a real system the amount of displacement due to jitter is a continuous random variable, the amount of displacement is somewhat irrelevant in switch-level simulation. Thus for purposes of switch-level simulation, the continuous random variable is discretized to one of three possibilities: aligned, leading, or lagging. In step 1212, a displacement is selected between a clock edge of a first pseudo-clock (PCLK1) and a corresponding clock edge of at least one other pseudo-clock (PCLK2) for each of N cycles. Thus there are three possible displacements between clock edges for PCLK1 and PCLK2 in any given cycle.

A simulation cycle is initiated in step 1214. If PCLK1 leads PCLK2 for a selected cycle as determined by step 1216, then PCLK1 is clocked (i.e., transitioned) in step 1220 and PCLK2 is subsequently clocked in step 1230. If PCLK1 lags PCLK2 for the selected cycle as determined by step 1218, then PCLK2 is clocked in step 1240 before clocking PCLK1 in step 1250. If the clock edge of PCLK1 neither leads nor lags the corresponding clock edge of PCLK2 for the selected cycle, then PCLK1 and PCLK2 are aligned. To simulate aligned clock edges, PCLK1 and PCLK2 are clocked simultaneously in step 1260.

Step 1262 determines if there is another clock cycle to be simulated. If so, the process returns to step 1214 to initiate another simulation cycle. If not, then at least a portion of the last result vector is analyzed in step 1270 for verification.

Results generated before all clock edges in a set of misaligned clock edges have transitioned for a particular cycle may indicate logic anomalies, however, such a result is merely an intermediate anomaly. Thus for example, any result vector generated after step 1220 and before step 1230 would be an “intra-cycle” result vector and should be ignored. Depending upon simulation methodology “inter-cycle” result vectors generated after any but the last cycle might be ignored in some cases for verification.

Although intermediate results between clock transitions may not match final results when the pseudo-clocks are misaligned, verification is typically only concerned with whether specific node data at specific points in time match corresponding results determined by the intended functional requirements. Thus verification is typically directed towards a subset of the node values that may be identified by spatial location (e.g., output nodes of only some of the logic elements) and time (i.e., after specific cycles have occurred).

The examples of FIGS. 3, 4, 5 and 9 are simplistic. Integrated circuits typically have a large number of logic elements. Intermediate anomalies (e.g., either “intra-cycle” or “inter-cycle”) for some nodes at particular points in time may not cause or indicate an incorrect logic result from a verification standpoint.

The correctness of the result may be determined by comparing the result vector from a simulation of the second logic design with a result vector associated with simulation of the first logic design with the same test vector. Depending upon simulation methodology, verification is performed by comparing at least a subset of the result vector generated by the jittered clock simulation of the second logic design with a subset of a reference vector that may be generated by simulation of the first logic design with the same test vector. Portions of the test vector will not actually be used during simulation of the first logic design because the signals do not have a corresponding counterpart in the first logic design.

For a proper comparison, the simulation of both the first and second logic designs is initiated with the same node data. A different type of simulation may be used for purposes of comparison. A gate-level simulation may be performed on the first logic design to generate a result vector for comparison with a result vector generated by a switch-level simulation of the second logic design.

Each distinct clock in the first logic design has a corresponding pseudo-clock in the second logic design. For example, if the plurality of logic elements of the first logic design shared a common clock, one of the pseudo-clocks used in the simulation of the second logic design matches the common clock. If the number of distinct clocks in the first logic design is K, then the number of distinct pseudo-clocks, M, in the second logic design is selected to ensure M≧K for simulation. The designer may then refine the design, if necessary, to create a more robust logic design in view of the analysis of the result vectors.

Switch-level simulation is a software simulation of the logic design and thus may be performed on a computer. The switch-level abstraction views the logic design as a collection of elements including transistors, passive components, storage elements, and their interconnections. The transistors are modeled as switches. The state of a given switch (e.g., open or closed) is a function of the values appearing at other nodes. A switch-level model of the logic design is described using a netlist. A netlist is a data file that defines the logic design as a collection of nodes and switches.

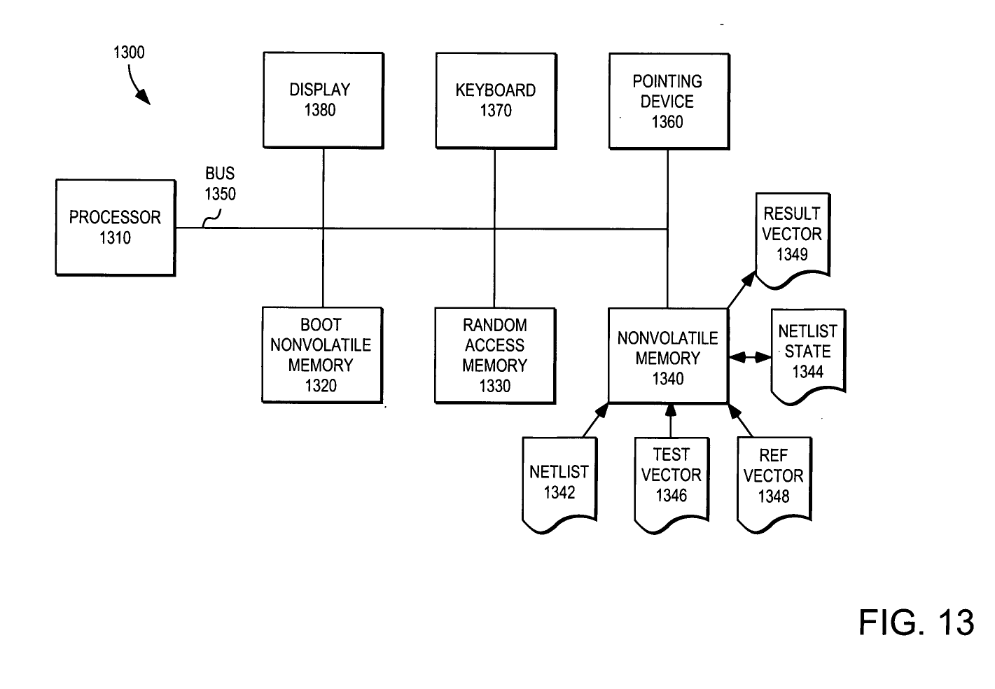

FIG. 13 illustrates one embodiment of a computer architecture 1300 that can be used to perform switch-level simulation of a logic design. In one embodiment, the method of converting from a first logic design to a second logic design as set forth in FIGS. 7-9 is performed by a computer having a similar architecture. In one embodiment, the simulation computer is the same as the computer that performs the conversion steps.

Computer 1300 includes processor 1310 capable of executing instructions to perform the steps of the processes for simulating or conversion or both. Input devices such as pointing device 1360 (e.g., mouse) and keyboard 1370 permit the user to interact with computer 1300. Information generated by the processor may be provided to an output device such as display 1380. Computer 1300 typically includes random access memory (RAM) 1330 that is used by the processor for executing application programs.

In one embodiment, computer 1300 includes nonvolatile memory 1340. Nonvolatile memory 1340 is used to retain programs and data even when the computer is powered down. In one embodiment nonvolatile memory 1340 is an electromechanical hard drive. In other embodiments, nonvolatile memory 1340 is a semiconductor nonvolatile memory. Another nonvolatile memory stores the bootstrap code required to boot the computer system. Boot nonvolatile memory 1320 is typically a semiconductor nonvolatile memory.

Pointing device 1360, keyboard 1370, RAM 1330, and nonvolatile memory 1340 are typically communicatively coupled to processor 1310 through one or more address and data buses such as bus 1350.

The netlist to be switch-level simulated may be stored as a netlist file 1342 with the nonvolatile memory 1340. Processor 1310 may retrieve portions of the netlist file 1342 and place them in RAM 1330 for executing the simulation and presenting the results on display 1380. Test vector file 1346 comprises one or more vectors that describe values presented to various nodes of the netlist as well as the state of the individual pseudo-clocks for each clock cycle. Processor 1310 generates a netlist state for each test vector applied to the netlist. The netlist states may be read and written to netlist state file 1344.

The simulation results are written to result vector file 1349. In one embodiment, the netlist state file 1344 maintains only a “window” of data as needed to generate the result vector necessary to generate the result vector file 1349 as the simulation progresses. Alternatively, the netlist state file 1344 may maintain a complete history of the node states throughout the simulation. The result vector file 1349 provides node state data for the purposes of verification. Typically, verification is concerned only with a subset of the netlist states throughout the simulation. Thus the result vector file 1349 will typically be a subset of the complete history of the nodes states throughout the simulation.

For example, the netlist state file 1344 must generally track the input and output node values for every logic element as the simulation progresses in order to be able to determine the results for subsequent pseudo-clock cycles during the simulation. For verification purposes, the designer might only be concerned with the node states of a subset of all the logic elements (i.e., spatial subset). Alternatively, the designer might only be concerned with the node states of all the logic elements only at particular points in time (i.e., timing subset). The designer might even only be concerned with the node states of a subset of the logic elements only at selected points in time during the simulation. Depending upon the simulation methodology, the designer may even only be concerned with output node data for selected logic elements at the end of the simulation.

Regardless of the simulation methodology, after the simulation is completed the result vector file 1349 may provide less than the node state data of all the logic elements at each point in time of the simulation. At least a portion of the result vector is analyzed for logical correctness (i.e., verification).

A determination as to whether the verification process failed may be made by comparing at least a subset of the result vector file 1349 with a subset of the reference vector file 1348. The reference vector file 1348 is based on applying the same test vector data to the first logic design. In effect, the reference vector file 1348 identifies the correct results for the given test vector data. In one embodiment, the reference vector file is generated from a protocol checker. A protocol checker is specifically designed to provide results in response to specific input data in accordance with a pre-determined defined protocol or standard.

Logic anomalies resulting from a jittered clock might be data dependent. Thus errors can occur as a result of misaligned clock edges for particular values or sequence of values of input data or based upon a particular state of the logic (i.e., for particular input data in view of current output data).

Testing every possible combination of cycle-by-cycle clock edge alignment, data sequences, input values, and logic state may be impossible or infeasible as a practical matter. Instead of attempting to define and test every possible combination, simulation for more complex logic designs may be performed with a large number of randomly generated test vectors in order to identify possible logical errors due to jitter.

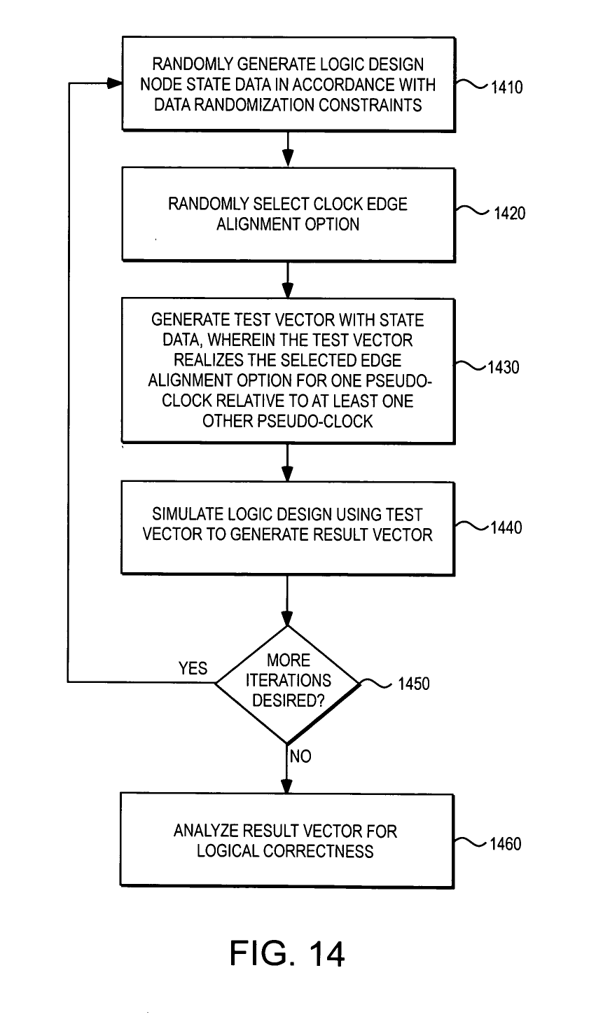

FIG. 14 illustrates one embodiment of a method for simulating jitter using randomized test vectors. In step 1410, netlist state data is generated in accordance with data randomization constraints. Such constraints may be used to impose bounds upon the input or state data or to ensure that the values match a particular probability distribution function over time. For example, the randomization constraints may require that a sequence of a pre-determined number of zeros occurs every k bits for a particular gate input.

In step 1420, a clock edge alignment option is selected. This selection may define edge alignment between more than two pseudo-clocks, however, on an individual cycle basis the option will determine whether a selected clock edge of at least one pseudo-clock leads, lags, or is aligned with the corresponding clock edge of at least one other pseudo-clock. Although the choice of alignment is variable, cycle variant, and otherwise independent of the input data or historical alignment choices, in one embodiment the choice of alignment may be influenced by randomization constraints such as “leading 50% of the time”.

One or more test vectors is generated in step 1430 using the randomly generated netlist state data and the clock edge alignment options. Depending upon the choice of simulation methodology, a plurality of test vectors (i.e., a test vector set) may be better suited for verification than a single test vector. The test vector set is composed of one or more test vectors that are sequentially applied to the logic design during simulation.

Simulation is performed in step 1440 using the test vector (or test vector set) to generate a result vector. If more simulation is desired as determined in step 1450, the process returns to step 1410 to generate more data for further simulation. In one embodiment, one of a switch-level or gate-level simulation is performed in step 1440. In alternative embodiments, simulation is performed at another level. For example, in alternative embodiments behavioral or functional simulation are performed in step 1440.

The result vector may be analyzed in step 1460 to identify logical anomalies. For results associated with clock edges that are supposed to be aligned in the absence of jitter, intermediate results may be ignored. The result vector may reflect only the subset of all node data at each point in time for all the logic elements. For example, verification may only be concerned with the some of the node values (e.g., output nodes) of some of the logic elements (e.g., only elements providing outputs to devices or elements external to the first logic design) at particular points in time.

Verification checkpoints are defined by spatial address (i.e., particular output of a particular logic element) and time (e.g., cycle). In one embodiment, analysis is performed by comparing at least a subset of the result vector with a reference vector generated by applying the same test vector to the first logic design. A mismatch in the selected node values at corresponding verification checkpoints of the result and reference vectors indicates a logic anomaly.

In the preceding detailed description, the invention is described with reference to specific exemplary embodiments thereof. In one embodiment, a first logic design having a plurality of clocked logic elements is converted to a second logic design having M groups of logic elements wherein each group has a distinct pseudo-clock. Test vectors used for simulation define edge displacements between a selected clock edge of one pseudo-clock and a corresponding edge of another pseudo-clock.

Possible displacements may include the first pseudo-clock having a selected edge that leads a corresponding edge of the second pseudo-clock, the first pseudo-clock having a selected edge that lags a corresponding edge of the second pseudo-clock, and the first pseudo-clock having a selected edge aligned with a corresponding edge of the second pseudo-clock. The edge displacement between the first and second pseudo-clocks may vary from cycle to cycle in order to appropriately model jitter as opposed to cycle invariant skew. Test vectors may define the pseudo-clock transitions for simulation such that a displacement between corresponding clock edges associated with one cycle is different than the displacement between corresponding clock edges of at least one other cycle.

Various modifications and changes may be made thereto without departing from the broader spirit and scope of the invention as set forth in the claims. The specification and drawings are, accordingly, to be regarded in an illustrative rather than a restrictive sense.

1. A method of testing a logic design, comprising:
identifying a plurality of clocked logic elements of a first logic design;
subdividing the plurality of logic elements into M individual groups of elements;
assigning a distinct pseudo-clock to each of the M groups to form a second logic design; and
performing a simulation on the second logic design with the M pseudo-clocks.

2. The method of claim 1 wherein the simulation comprises performing one of a gate-level and a switch-level simulation of the second logic design.

3. The method of claim 2 wherein the simulation further comprises using test vectors that provide a distinct transition for each of the M pseudo-clock signals relative to any other of the M pseudo-clock signals.

4. The method of claim 2 wherein the simulation further comprises applying a test vector that defines a relative displacement between corresponding pseudo-clock edges for each cycle, wherein a clock edge of a first pseudo-clock has a leading displacement from a corresponding clock edge of another pseudo-clock in one cycle, wherein there is at least one cycle such that the clock edge of the first pseudo-clock does not have a leading displacement from the corresponding clock edge of another pseudo-clock.

5. The method of claim 2 wherein the simulation further comprises applying a test vector that defines a relative displacement between corresponding pseudo-clock edges for each cycle, wherein a clock edge of a first pseudo-clock has a leading displacement from a corresponding clock edge of any other pseudo-clock in one cycle, wherein there is at least one cycle such that the clock edge of the first pseudo-clock does not have a leading displacement from the corresponding clock edge of every other pseudo-clock.

6. The method of claim 2 wherein the simulation further comprises applying a test vector that defines a relative displacement between corresponding pseudo-clock edges for each cycle, wherein a clock edge of a first pseudo-clock has a lagging displacement from another pseudo-clock in one cycle, wherein there is at least one cycle such that the clock edge of the first pseudo-clock does not have a lagging displacement from the corresponding clock edge of another pseudo-clock.

7. The method of claim 2 wherein the simulation further comprises applying an N-cycle test vector that defines each of the M pseudo-clocks, wherein the displacement between a clock edge of a first pseudo-clock and a corresponding clock edge of a second pseudo-clock is different for at least two of the N cycles.

8. The method of claim 2 wherein the simulation further comprises applying an N-cycle test vector that defines a constant displacement between a first pseudo-clock edge and a corresponding second pseudo-clock edge across the N cycles.

9. A method of testing a logic design, comprising:
identifying a first logic design having a plurality of clock domains, each associated with a distinct clock;
generating one or more test vector sets that define a displacement between corresponding edges of the clocks for each clock cycle, wherein there is at least one clock cycle having an associated displacement distinct from the displacement associated with another cycle; and
performing one of a gate-level and a switch-level simulation on the first logic design using the one or more test vector sets.

10. The method of claim 9 wherein generating one or more test vector sets comprises generating a plurality of test vector sets, wherein at least one test vector set establishes the edge of the first clock leading the edge of the second clock for a selected cycle, wherein at least one test vector set establishes the edge of the first clock lagging the edge of the second clock for the selected cycle, wherein at least one test vector set establishes the edges of the first and second clocks as being aligned for the selected cycle, wherein in at least one other cycle each test vector set establishes a different displacement than that established in the selected cycle.

11. The method of claim 9 wherein generating one or more test vector sets comprises generating a plurality of test vector sets having randomly selected netlist state and input data, wherein the netlist state and input data is randomly selected in accordance with randomization constraints.

12. The method of claim 11 wherein the performing one of a gate-level and a switch-level simulation comprises performing a switch-level simulation.

13. The method of claim 11 wherein for a selected test vector set a clock edge displacement is randomly selected from the set of leading, aligned, and lagging for each cycle, wherein the displacement varies across cycles.

14. The method of claim 9 wherein the identifying a first logic design further comprises:
i) identifying a plurality of logic elements in an original logic design that share a common clock signal;
ii) subdividing the plurality of logic elements into M individual groups of elements; and
iii) replacing the common clock signal with a distinct pseudo-clock signal for each of the M groups to form the candidate logic design.

15. A computer-readable storage medium storing processor-executable instructions, wherein when executed by a processor the instructions instruct the processor to perform the steps of:
a) identifying a plurality of clocked logic elements of a first logic design;
b) subdividing the plurality of logic elements into M individual groups of elements; and
c) replacing the common clock signal with a distinct pseudo-clock for each of the M groups to form a second logic design, wherein each of the M groups of logic elements is associated with a distinct clock domain.

16. The computer-readable storage medium of claim 15, wherein the instructions further instruct the processor to generate a test vector set that defines a displacement between corresponding edges of the pseudo-clocks for each cycle, wherein a first pseudo-clock edge has a leading displacement from a second pseudo-clock edge in one cycle, wherein there is at least one cycle such that the first pseudo-clock does not have a leading displacement from the second pseudo-clock.

17. The computer-readable storage medium of claim 15, wherein the instructions further instruct the processor to generate a test vector set that defines a displacement between corresponding edges of the pseudo-clocks for each cycle, wherein a first pseudo-clock edge has a leading displacement from any other pseudo-clock edge in one cycle, wherein there is at least one cycle such that the first pseudo-clock is not leading all other pseudo-clocks.

18. The computer-readable storage medium of claim 15, wherein the instructions further instruct the processor to generate a test vector set that defines a displacement between corresponding edges of the pseudo-clocks for each cycle, wherein a first pseudo-clock edge has a lagging displacement from a second pseudo-clock edge in one cycle, wherein there is at least one cycle such that the first pseudo-clock does not have a lagging displacement from the second pseudo-clock.

19. The computer-readable storage medium of claim 15, wherein the instructions further instruct the processor to generate a test vector set that defines a displacement between corresponding edges of the pseudo-clocks for each cycle, wherein a first pseudo-clock edge has a lagging displacement from any other pseudo-clock edge in one cycle, wherein there is at least one cycle such that the first pseudo-clock is not lagging all other pseudo-clocks.

20. The computer-readable storage medium of claim 15, wherein the instructions further instruct the processor to:
generate a test vector set that defines a displacement between corresponding edges of at least two pseudo-clocks for each cycle, wherein the displacement for at least one cycle is different than the displacement for another cycle; and
perform a switch-level simulation of the second logic design using the test vector set.

21. A system for testing a logic design comprising:
a) means for identifying a plurality of clocked logic elements of a first logic design;
b) means for subdividing the plurality of logic elements into M individual groups of elements;
c) means for assigning a distinct pseudo-clock to each of the M groups to form a second logic design;
d) means for performing a simulation on the second logic design with the M pseudo-clocks.

22. The method of claim 21 wherein the means for performing a simulation comprises means for performing one of a gate-level and a switch-level simulation of the second logic design.

23. The method of claim 22 wherein the simulation further comprises using test vectors that provide a distinct transition for each of the M pseudo-clock signals relative to any other of the M pseudo-clock signals.

24. The method of claim 22 wherein the simulation further comprises applying a test vector that defines a relative displacement between corresponding pseudo-clock edges for each cycle, wherein a clock edge of a first pseudo-clock has a leading displacement from a corresponding clock edge of another pseudo-clock in one cycle, wherein there is at least one cycle such that the clock edge of the first pseudo-clock does not have a leading displacement from the corresponding clock edge of another pseudo-clock.

25. The method of claim 22 wherein the simulation further comprises applying a test vector that defines a relative displacement between corresponding pseudo-clock edges for each cycle, wherein a clock edge of a first pseudo-clock has a leading displacement from a corresponding clock edge of any other pseudo-clock in one cycle, wherein there is at least one cycle such that the clock edge of the first pseudo-clock does not have a leading displacement from the corresponding clock edge of every other pseudo-clock.

26. The method of claim 22 wherein the simulation further comprises applying a test vector that defines a relative displacement between corresponding pseudo-clock edges for each cycle, wherein a clock edge of a first pseudo-clock has a lagging displacement from another pseudo-clock in one cycle, wherein there is at least one cycle such that the clock edge of the first pseudo-clock does not have a lagging displacement from the corresponding clock edge of another pseudo-clock.

27. The method of claim 22 wherein the simulation further comprises applying an N-cycle test vector that defines each of the M pseudo-clocks, wherein the displacement between a clock edge of a first pseudo-clock and a corresponding clock edge of a second pseudo-clock is different for at least two of the N cycles.

28. The method of claim 22 wherein the simulation further comprises applying an N-cycle test vector that defines a constant displacement between a first pseudo-clock edge and a corresponding second pseudo-clock edge across the N cycles.

29. A method of testing a logic design, comprising:
means for identifying a first logic design having a plurality of clock domains, each associated with a distinct clock;
means for generating at least one test vector set that defines a displacement between corresponding edges of the clocks for each clock cycle, wherein there is at least one clock cycle having an associated displacement distinct from the displacement associated with another cycle; and
means for performing one of a gate-level and a switch-level simulation on the first logic design using the test vector set.

30. The method of claim 29 wherein the means for generating at least one test vector set comprises means for generating a plurality of test vector sets, wherein at least one test vector set establishes the edge of the first clock leading the edge of the second clock for a selected cycle, wherein at least one test vector set establishes the edge of the first clock lagging the edge of the second clock for the selected cycle, wherein at least one test vector set establishes the edges of the first and second clocks as being aligned for the selected cycle, wherein in at least one other cycle each test vector set establishes a different displacement than that established in the selected cycle.

31. The method of claim 29 wherein the means for generating at least one test vector set comprises means for generating a plurality of test vector sets having randomly selected netlist state and input data, wherein the netlist state and input data is randomly selected in accordance with randomization constraints.

32. The method of claim 31 wherein the means for performing one of a gate-level and a switch-level simulation comprises means for performing a switch-level simulation.

33. The method of claim 31 wherein for a selected test vector set a clock edge displacement is randomly selected from the set of leading, aligned, and lagging for each cycle, wherein the displacement varies across cycles.

34. The method of claim 29 wherein the means for identifying a first logic design further comprises:
i) means for identifying a plurality of logic elements in an original logic design that share a common clock signal;
ii) means for subdividing the plurality of logic elements into M individual groups of elements; and
iii) means for replacing the common clock signal with a distinct pseudo-clock signal for each of the M groups to form the candidate logic design.
